(19) United States
(12) Patent Application Publication
(10) Pub. No.: US 2026/0092947 A1
(43) Pub. Date: Apr. 2, 2026

(54) Sensor Module

(71) Applicant: SEIKO EPSON CORPORATION, Tokyo (JP)

(72) Inventors: Yasuhiro SUDO, Chino (JP); Shoei NOMURA, Minowa (JP); Ryuta NISHIZAWA, Nagano (JP); Takeru SAKAIDE, Minowa (JP); Tomoaki TAKAHASHI, Minowa (JP)

(21) Appl. No.: 19/341,418

(22) Filed: Sep. 26, 2025

(30) Foreign Application Priority Data
Sep. 27, 2024 (JP) 2024-168219

(51) Int. Cl. G01P 15/125; G01P 1/02; G01P 1/04; G01P 15/08; G01P 15/097; G01P 15/18

(52) U.S. Cl. CPC G01P 15/125; G01P 1/023; G01P 1/04; G01P 15/097; G01P 15/18; G01P 15/0888

(57) ABSTRACT

The sensor module includes a sensor that detects environmental information of an object equipped with the sensor module, a resonator, an integrated circuit device, and a package that houses the sensor, the resonator, and the integrated circuit device. An integrated circuit device includes an oscillation circuit configured to generate a clock signal using a resonator, a real-time clock circuit configured to generate time information based on the clock signal, and a processing circuit configured to output, as log information, output environmental information based on an output signal of a sensor in association with the time information from the real-time clock circuit.

The present application is based on, and claims priority from JP Application Serial Number 2024-168219, filed Sep. 27, 2024, the disclosure of which is hereby incorporated by reference herein in its entirety.

### BACKGROUND

### 1. Technical Field

The present disclosure relates to a sensor module.

### 2. Related Art

JP-A-2019-152563 discloses an impact detector. The impact detector includes a clock, an acceleration sensor, a controller, a storage, a wireless communication unit, a battery, and the like, all of which are housed in a casing made of translucent or transparent resin. The controller compares an acceleration measured by the acceleration sensor with a threshold and, when the threshold is exceeded, generates impact data associating the acceleration with its measurement date and time. The storage stores impact data. The wireless communication unit transmits the impact data stored in the storage to a portable terminal.

JP-A-2019-152563 does not disclose a specific structure usable as an environmental data logger during transportation and similar operations. For example, a sensor, such as an acceleration sensor, and a time-keeping function, such as a real-time clock, are prepared as separate components and modularized to form an environmental data logger. However, such a configuration has several drawbacks. Examples of the drawbacks include increased product size, power consumption, and cost of the environmental data logger.

### SUMMARY

An aspect of the present disclosure relates to a sensor module including a sensor configured to detect environmental information of an object equipped with the sensor module; a resonator; an integrated circuit device; and a package configured to house the sensor, the resonator, and the integrated circuit device. The integrated circuit device includes an oscillation circuit configured to generate a clock signal using the resonator, a real-time clock circuit configured to generate time information based on the clock signal, and a processing circuit configured to output, as log information, output environmental information based on an output signal of the sensor and the time information from the real-time clock circuit in association with each other.

### BRIEF DESCRIPTION OF THE DRAWINGS

FIG. 1 is an external perspective view of a sensor module that detects environmental information.

FIG. 2 illustrates a first installation example of the sensor module.

FIG. 3 illustrates a second installation example of the sensor module.

FIG. 4 is a block diagram illustrating a first circuit configuration example of a sensor module.

FIG. 5 is a block diagram illustrating a second circuit configuration example of the sensor module.

FIG. 6 is a block diagram illustrating a detailed configuration example of a sensor and a detection circuit.

FIG. 7 is a block diagram illustrating a first configuration example in which the power consumption of the detection circuit and a processing circuit is reduced.

FIG. 8 is a block diagram illustrating a second configuration example in which the power consumption of the detection circuit and the processing circuit is reduced.

FIG. 9 shows a signal waveform example of acceleration generated when a single impact is applied to the sensor module.

FIG. 10 is a graph illustrating a damage boundary curve.

FIG. 11 illustrates examples of log information.

FIG. 12 illustrates an example of an event detection method.

FIG. 13 illustrates a first structural example of a sensor module.

FIG. 14 illustrates the first structural example of the sensor module.

FIG. 15 illustrates a second structural example of the sensor module.

FIG. 16 illustrates a third structural example of the sensor module.

FIG. 17 illustrates the third structural example of the sensor module.

FIG. 18 illustrates a first example of a battery arrangement.

FIG. 19 illustrates a second example of the battery arrangement.

### DESCRIPTION OF EMBODIMENTS

Embodiments of the present disclosure will now be described in detail. The present embodiment described below does not unduly limit the scope of the appended claims, and the configurations described in the present embodiment are not all necessarily essential constituent elements.

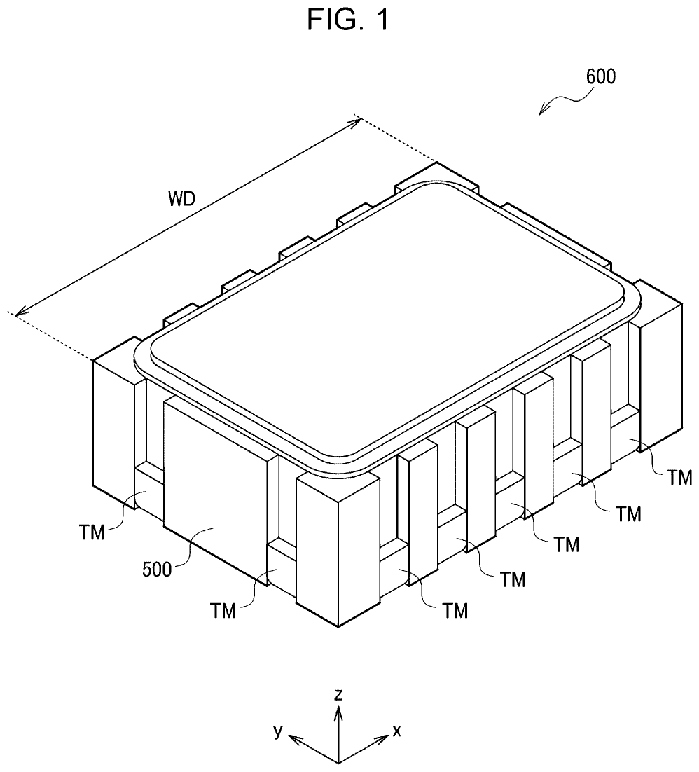

FIG. 1 is an external perspective view of a sensor module 600 that detects environmental information. The three mutually perpendicular directions are referred to as the x-direction, y-direction, and z-direction. The z-direction may also be referred to as the vertical direction.

The sensor module 600 includes a package 500 that houses a sensor, a resonator, and an integrated circuit device. The package 500 has a substantially rectangular parallelepiped shape, with its sides aligned along the x-, y-, and z-axes. A plurality of external connection terminals TM, which connects the integrated circuit device housed in the package 500 to the outside, are provided on the bottom surface of the package 500. FIG. 1 illustrates each external connection terminal TM as extending from the side surface to the bottom surface of the package 500; however, the shape of the external connection terminals TM is not limited to this configuration. The external connection terminals TM may be, for example, bump terminals provided on the bottom surface of the package 500, or lead terminals extending outward from the outer periphery of the bottom surface of the package 500.

The package 500 may be, for example, a ceramic package of the type used in oscillators with crystal resonators, sensors, or similar devices. Such a ceramic package may be considered to be a single component mounted on a printed circuit board or other substrate and is much smaller than a typical electronic device in which multiple components are combined and housed together in a casing. For instance, the longest side of the package 500 has a length WD of 20 mm or less. Although FIG. 1 illustrates an example in which the x-direction side is longest, the longest side may instead lie in the y-or z-direction. Thus, by using the small-sized package 500, the sensor module 600 enables the implementation of an environmental data logger that is significantly smaller than the impact detector as disclosed in JP-A-2019-152563. The package 500 is not limited to a ceramic package and may instead be formed from other materials, such as resin. Furthermore, although the sensor module 600 includes the external connection terminals TM, the sensor module 600 is not necessarily need to be mounted on a substrate, provided that power is supplied to the sensor module 600.

An installation example of the sensor module 600 will now be described. The sensor module 600 is used to sense and record environmental information during a physical distribution process. That is, it is installed in or near the item to be transported. The term “physical distribution process” as used herein include not only transportation but also packing and unpacking before and after transportation, as well as installation of the transported item. The sensor module 600 may be used during any of these phases: packing, transportation, unpacking, or installation.

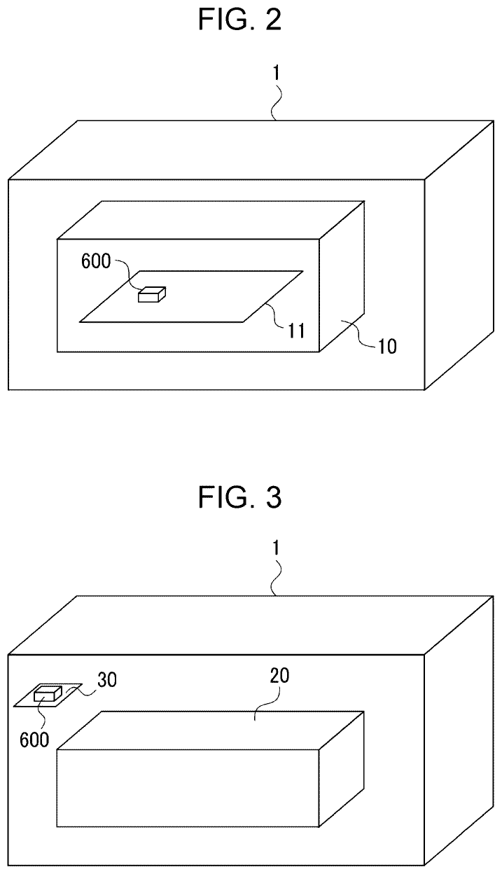

FIG. 2 illustrates a first installation example of the sensor module 600. The sensor module 600 is mounted on the substrate 11 of an electronic device 10. Various components, such as an integrated circuit (IC), resistors, capacitors, or connectors, may be mounted on the substrate 11 to implement the functions of the electronic device 10. Examples of the electronic device 10 may be, for example, a printer, projector, television set, camera, personal computer, display, game console, smartphone, smartwatch, head-mounted display, or audio equipment. The electronic device 10 is housed in a packing material 1 and transported. The sensor module 600 senses environmental information during the physical distribution process of the electronic device 10 equipped with the sensor module 600. Examples of the environmental information include impact, acceleration, angular velocity, temperature, dew point, dew condensation, humidity, odors, gases, forces, and pressure. The sensor module 600 detects one or more of these parameters.

FIG. 3 illustrates a second installation example of the sensor module 600. The sensor module 600 is built into an environmental data logger 30 that is separate from the electronic device 20. For example, the sensor module 600 is mounted on a substrate within the environmental data logger 30. The electronic device 20 is housed in the packing material 1, and the environmental data logger 30 is also arranged inside the same packing material 1. The sensor module 600 senses the environmental information in the environmental data logger 30, which is equipped with the sensor module 600, thereby enabling the sensing of the environmental information related to the electronic device 20 that is housed together with the environmental data logger 30 in the packing material 1.

Note that the electronic device 10 and the environmental data logger 30 are provided as examples of objects that are equipped with the sensor module 600, and various other items may also be equipped with the sensor module 600. The installation position of the environmental data logger 30 is not limited to the interior of the packing material 1. For example, the environmental data logger 30 may be placed inside a non-electronic item. Alternatively, the environmental data logger 30 may be arranged inside the cargo compartment of a motor vehicle, train, ship, or airplane used for transporting an item, or, for example, inside a container that stores the item during transportation.

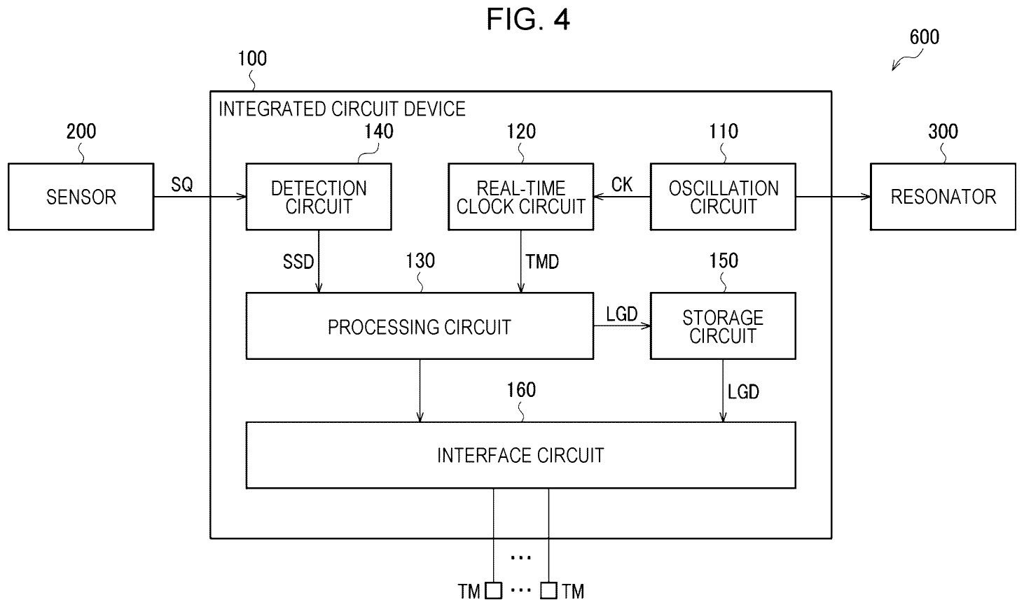

FIG. 4 is a block diagram illustrating a first circuit configuration example of the sensor module 600. The package 500 is omitted in the illustration. The sensor module 600 includes an integrated circuit device 100, a sensor 200, a resonator 300, and external connection terminals TM.

The sensor 200 detects environmental information and outputs an output signal SQ as the detection result. Specific examples of the sensor 200 will be described later. Although FIG. 4 illustrates a case in which the sensor module 600 includes a single sensor, the sensor module 600 may include a plurality of sensors.

The resonator 300 is an element that generates mechanical vibrations in response to an electrical signal. The resonator 300 may be implemented by a resonator piece such as a crystal resonator piece. The resonator 300 is, for example, a tuning-fork crystal resonator piece. Alternatively, the resonator 300 may be a crystal resonator piece with a cut angle such as AT cut or SC cut, and performs thickness shear vibration. Other possibilities include resonator pieces of types other than the tuning-fork and thickness shear vibration types, and piezoelectric resonator pieces formed from materials other than quartz crystal. For example, the resonator 300 may be a SAW resonator or a MEMS resonator, which is a silicon resonator formed using a silicon substrate. SAW stands for Surface Acoustic Wave, and MEMS stands for Micro Electro Mechanical Systems.

The integrated circuit device 100 includes an oscillation circuit 110, a real-time clock circuit 120, a processing circuit 130, a detection circuit 140, a storage circuit 150, and an interface circuit 160. For example, the integrated circuit device 100 is a semiconductor substrate in which a plurality of circuit elements are integrated.

The oscillation circuit 110 drives the resonator 300 to cause the resonator 300 to oscillate, and generates a clock signal CK based on the oscillating signal. A non-limiting example of the oscillation circuit 110 is a Colpitts oscillator. Additionally, if the sensor 200 includes a resonator, the resonator of the sensor 200 may also serves as the resonator 300, and the drive circuit for driving the resonator of the sensor 200 may function as the oscillation circuit 110. A specific example will be described later along with specific examples of the sensor 200.

The real-time clock circuit 120 is a circuit that provides a clock function and generates time information TMD indicating the current time by counting based on the clock signal CK. For example, the real-time clock circuit 120 includes a frequency divider circuit that divides the frequency of the clock signal CK and a time counter that tracks the current time using the divided signal. The time information TMD may be, for example, the count value from the time counter, or data representing some or all of the following: year, month, day, hour, minute, and second.

The detection circuit 140 performs detection processing on the output signal SQ from the sensor 200 and outputs sensor detection information SSD as the result. The output signal SQ is, for example, a charge, current, voltage, or other analog signal. The sensor detection information SSD may be digital data suitable for handling by a logic circuit in a subsequent stage. The digital data is not limited to multi-bit data and includes binary (1-bit) signals. For example, the detection circuit 140 may include an analog-to-digital (A/D) conversion circuit that converts the output signal SQ from analog to digital and outputs the resulting sensor detection information SSD. Alternatively, the detection circuit 140 may further include an amplifier circuit that amplifies the output signal SQ prior to A/D conversion. If the output signal SQ includes a carrier wave signal and a detection signal, the detection circuit 140 may further a demodulator to extract the detection signal from the output signal SQ prior to the A/D conversion circuit. In the case where the sensor detection information SSD is binary output, the detection circuit 140 may include a comparator that compares the output signal SQ to a reference voltage corresponding to a threshold.

The processing circuit 130 outputs output environmental information, based on the sensor detection information SSD, and outputs the resulting time information TMD as log information LGD. The output environmental information may be the sensor detection information SSD itself or may be information derived by performing operations on the sensor detection information SSD. These operations may include, for example, addition, subtraction, multiplication, division, differentiation, integration, or statistical processing. The processing circuit 130 may continuously output the log information LGD, or may output the log information LGD only when a detection event of the environmental information occurred. A specific example of the log information LGD will be described later. The processing circuit 130 includes, for example, a DSP that performs arithmetic processing on the sensor detection information SSD. DSP stands for Digital Signal Processor. The processing circuit 130 may include a control circuit. The control circuit may control some or all of the detection circuit 140, the real-time clock circuit 120, the oscillation circuit 110, the storage circuit 150, and the interface circuit 160. Control-related arrow lines are not illustrated in the drawings. Some or all of the DSP, the control circuit, and the real-time clock circuit 120 may be implemented as an integrated logic circuit using automated place-and-route or the like.

The storage circuit 150 stores the log information LGD output from the processing circuit 130. The storage circuit 150 is a semiconductor memory and is a RAM or a nonvolatile memory. The RAM is, for example, SRAM or DRAM. SRAM stands for Static Random Access Memory, and DRAM stands for Dynamic Random Access Memory. The nonvolatile memory may be an electrically writable ROM, such as EEPROM. EEPROM stands for Electrically Erasable Programmable Read-Only Memory.

The interface circuit 160 communicates with the outside of the sensor module 600 via the external connection terminals TM. The interface circuit 160 outputs the log information LGD stored in the storage circuit 150 to the outside. For example, in response to a read instruction from the outside, the interface circuit 160 reads the log information LGD from the storage circuit 150 and outputs it to the outside. Alternatively, the interface circuit 160 may output the log information LGD directly from the processing circuit 130 to the outside, without passing the log information LGD through the storage circuit 150. The interface circuit 160 may be an inter-circuit communication interface circuit that complies with any one of various standards. For example, the interface circuit 160 is a serial communication interface circuit in a Serial Peripheral Interface (SPI) mode or an Inter-Integrated Circuit (I2C) mode. SPI stands for Serial Peripheral Interface, and I2C stands for Inter-Integrated Circuit.

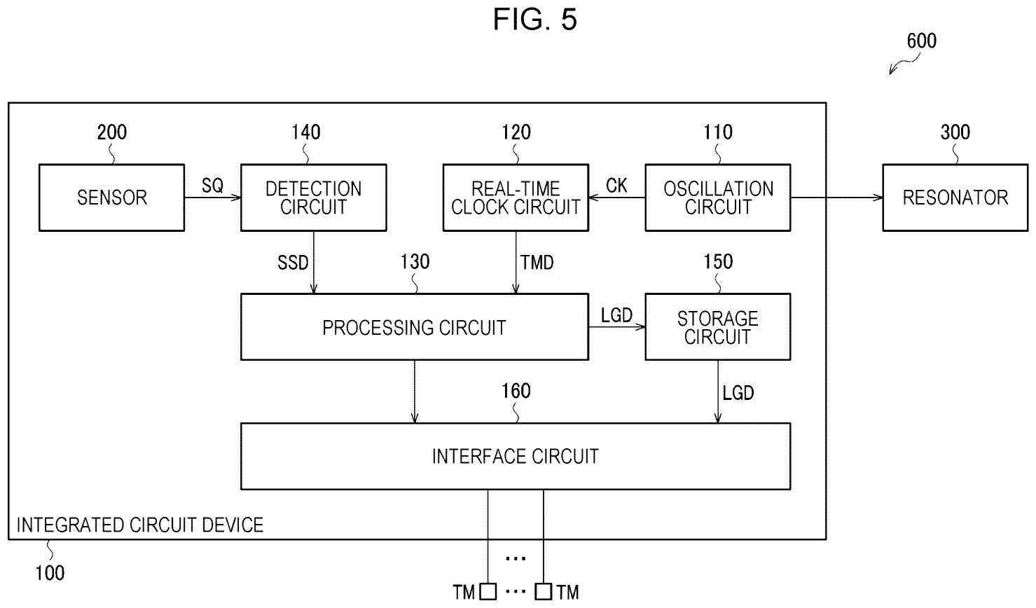

FIG. 5 is a block diagram illustrating a second circuit configuration example of the sensor module 600. In this example, the integrated circuit device 100 includes the sensor 200. If the sensor 200 can be formed on a semiconductor substrate, this configuration is possible. The configuration and operation of each component are the same as in the first circuit block example. In this example, the integrated circuit device 100, which includes the sensor 200, is housed in the package 500. Thus, both the sensor 200 and the integrated circuit device 100 are housed within the package 500.

Specific examples of the sensor 200 are described below.
(1) Acceleration sensor: The sensor 200 may be, for example, a capacitive acceleration sensor made of silicon MEMS. MEMS stands for Micro Electro Mechanical Systems. Alternatively, the sensor 200 may be an acceleration sensor using a crystal resonator, a piezoelectric element, or other type. The sensor module 600 including such an acceleration sensor can be used as, for example, a shock data logger. That is, using the acceleration sensor, the sensor module 600 detects and records impacts applied to an object equipped with the sensor module 600 as environmental information.
(2) Condensation sensor: The sensor 200 may be a sensor that detects a condensation state. Here, the condensation state refers, for example, to the presence or absence of condensation, and the sensor 200 detects the presence or absence of condensation. The sensor 200 may directly detect condensation or indirectly detect it by determining whether the humidity has reached 100%.
(3) Odor sensor: The sensor 200 may be, for example, a gas sensor that senses odors by detecting gases in the air.
(4) Force sensor: The sensor 200 may be, for example, a load sensor using a crystal resonator. The sensor 200 includes a crystal double-ended tuning fork (DETF) resonator and a cantilever. When a force is applied to the cantilever, the tension on the crystal DETF resonator changes. The change in tension causes a shift in the vibration frequency of the crystal DETF resonator. This frequency shift enables the detection of the applied force. Alternatively, the sensor 200 may be a force or pressure sensor using silicon MEMS technology.
(5) Temperature sensor: The sensor 200 may be, for example, a thermistor, thermocouple, or resistance temperature detector. Alternatively, the sensor 200 may be a temperature sensor that measures temperature using the temperature characteristics of the forward voltage of a p-n junction. Such a temperature sensor may be built into the integrated circuit device 100, as illustrated in FIG. 5. The integrated circuit device 100 may include, for example, a temperature sensor and a temperature compensation circuit that performs the temperature compensation of the oscillation frequency of the oscillation circuit 110 based on a detection signal of the temperature sensor. The temperature sensor used for the temperature compensation may also serve as the sensor 200.
(6) Angular velocity sensor: The sensor 200 may be a gyro sensor using a crystal resonator or a MEMS resonator. For example, the crystal resonator includes driving arms and sensing arms, and the drive circuit drives the driving arms to vibrate the driving arms. When the Coriolis force is generated due to the angular velocity, the vibration states of the sensing arms change. By detecting the changes, the angular velocity can be detected. This crystal resonator may also serve as the resonator 300 for generating the clock signal CK. In this case, a drive circuit that drives the driving arms corresponds to the oscillation circuit 110.

Environmental information is detected using the sensor 200 as described above and is stored together with time information obtained by the real-time clock circuit 120, enabling an environmental data logger in a physical distribution process to be configured. The time information is recorded, which enables, for example, the time at which a specific event has occurred to be known later. By collating such log information with information indicating the time at which each stage of the physical distribution is performed, it is possible to estimate at which stage of the physical distribution a specific event has occurred.

In addition, the sensor 200, the integrated circuit device 100, and the resonator 300 as illustrated in FIG. 4 or 5 are housed in the package 500 as illustrated in FIG. 1 to configure the sensor module 600, and thus it is possible to solve the disadvantages of the environmental data logger. For example, it is possible to configure a compact and inexpensive environmental data logger or a compact, inexpensive, and low power consumption environmental data logger. Transportation objects in physical distribution have various sizes or prices. It is hard to use an environmental data logger that is relatively large for a transportation object or an environmental data logger that is relatively expensive for the transportation object. In this respect, the sensor module 600 in the present embodiment is small and inexpensive and therefore is easy to use for any transportation object. Additionally, since a certain amount of time is taken for a physical distribution process, a power source for operating the environmental data logger is needed during the period. The larger the power consumption, the larger-capacity and heavier battery is to be used. However, the sensor module 600 in the present embodiment allows reduction in power consumption, enabling the use of a smaller-capacity and lighter battery.

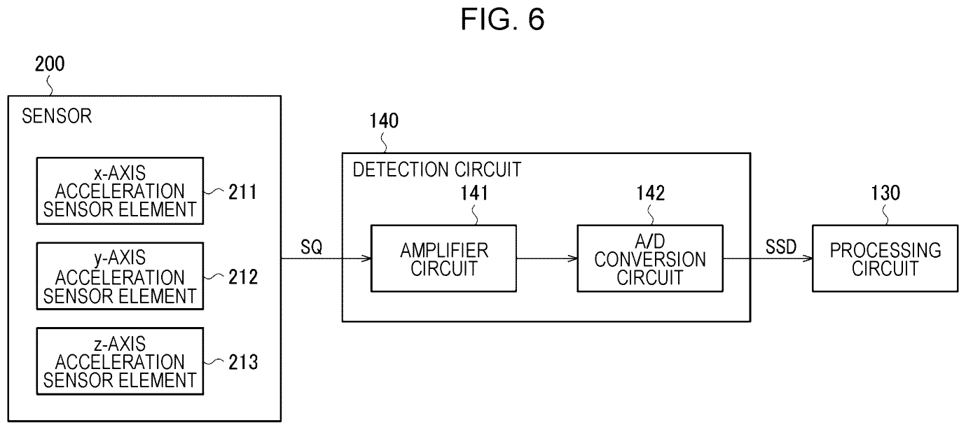

Taking the example of a shock data logger using a MEMS acceleration sensor, a detailed configuration example and an operation example will be described hereafter. FIG. 6 is a block diagram illustrating a detailed configuration example of the sensor 200 and the detection circuit 140.

The sensor 200 includes an x-axis acceleration sensor element 211, a y-axis acceleration sensor element 212, and a z-axis acceleration sensor element 213. Although the example in which the sensor 200 is a three-axis acceleration sensor is illustrated here, the sensor 200 may be a one-axis or two-axis acceleration sensor. The sensor 200 has a substantially plate-like shape parallel to the XY-plane. In a specific example, the sensor 200 includes a support substrate having a bottom surface parallel to the XY-plane and a lid bonded to the support substrate. The x-axis acceleration sensor element 211, the y-axis acceleration sensor element 212, and the z-axis acceleration sensor element 213 are arranged on the support substrate and are covered with the lid.

The x-axis acceleration sensor element 211 includes a comb-shaped fixed electrode fixed to the support substrate, a movable portion configured to be movable with respect to the support substrate, and a comb-shaped movable electrode fixed to the movable portion. The comb teeth of the fixed electrode and the comb teeth of the movable electrode are arranged to face each other in the x-direction. When acceleration in the x-direction is applied to the x-axis acceleration sensor element 211, the movable portion moves in the x-direction to change the distance between the comb teeth, resulting in a change in the capacitance between the comb teeth. By detecting the change in the capacitance, the detection circuit 140 detects the acceleration in the x-direction as the sensor detection information SSD. The y-axis acceleration sensor element 212 has a similar configuration.

The Z-axis acceleration sensor element 213 includes a comb-shaped fixed electrode fixed to the support substrate, a movable portion capable of swinging about a rotation shaft parallel to the XY-plane, and a comb-shaped movable electrode fixed to the movable portion. The comb teeth of the fixed electrode and the comb teeth of the movable electrode are disposed so as to face each other in the x-direction or the y-direction. When acceleration in the z-direction is applied, the movable portion swings to change the overlapping area between the comb teeth, resulting in a change in the capacitance between the comb teeth. By detecting the change in the capacitance, the detection circuit 140 detects the acceleration in the z-direction as the sensor detection information SSD.

The detection circuit 140 includes an amplifier circuit 141 and an A/D conversion circuit 142. The amplifier circuit 141 and the A/D conversion circuit 142 may be provided for each of the x-axis acceleration sensor element 211, the y-axis acceleration sensor element 212, and the z-axis acceleration sensor element 213. Alternatively, the detection circuit 140 may include a selector, and the selector may select the output signals of the x-axis acceleration sensor element 211, the y-axis acceleration sensor element 212, and the z-axis acceleration sensor element 213 in a time-division manner and output the selected output signals to the amplifier circuit 141.

The detection circuit 140 includes the amplifier circuit 141 and the A/D conversion circuit 142. Here, it is assumed that SQ represents the output signal of the x-axis acceleration sensor element 211, but the same applies to the output signals of the y-axis acceleration sensor element 212 and the z-axis acceleration sensor element 213.

The amplifier circuit 141 converts the output signal SQ of the x-axis acceleration sensor element 211 from a charge (C) signal to a voltage (V) signal (Q/V conversion) and amplifies the voltage signal. The A/D conversion circuit 142 converts the output signal of the amplifier circuit 141 from analog to digital (A/D conversion) and outputs a result of the A/D conversion, which is x-axis acceleration data, as the sensor detection information SSD.

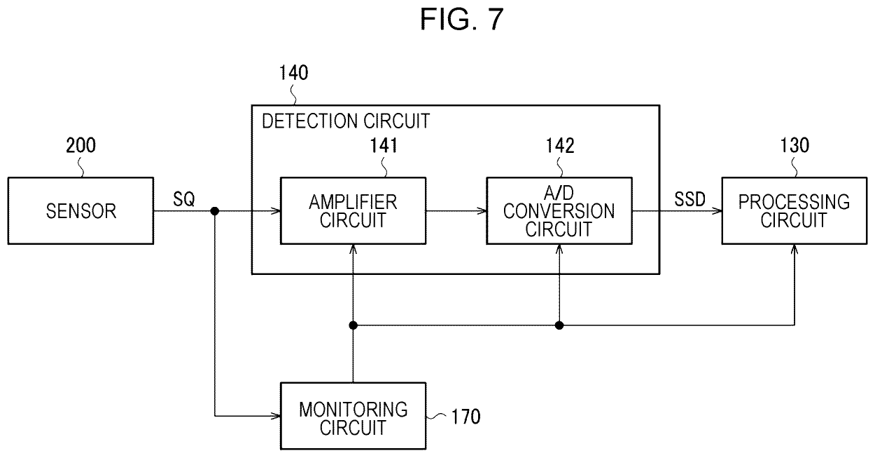

FIG. 7 is a block diagram illustrating a first configuration example in which the power consumption of the detection circuit 140 and the processing circuit 130 is reduced. The integrated circuit device 100 further includes a monitoring circuit 170.

The monitoring circuit 170 monitors whether the output signal SQ of the sensor 200 has reached a predetermined level. When the predetermined level is reached, the monitoring circuit 170 causes the detection circuit 140 and the processing circuit 130 to transition from a low power consumption mode to a normal operation mode. The monitoring circuit 170 causes the detection circuit 140 and the processing circuit 130 to transition from the normal operation mode to the low power consumption mode, for example, when the output signal SQ reaches the predetermined level and then reaches a second predetermined level, or when a certain period of time has elapsed since the output signal SQ reached the predetermined level. The monitoring circuit 170 includes, for example, a comparator that compares the output signal SQ with the predetermined level. At least one of the detection circuit 140 and the processing circuit 130 may be in the low power consumption mode. Additionally, at least a portion of the detection circuit 140 may be in the low power consumption mode. The predetermined level is determined depending on what environmental information is to be detected for recording the log information LGD. If the log information LGD is to be recorded when environmental information greater than or equal to a predetermined value is detected, it is sufficient that the monitoring circuit 170 detect whether the output signal SQ exceeds a predetermined level. Alternatively, if the log information LGD is to be recorded when environmental information less than or equal to a predetermined value is detected, it is sufficient that the monitoring circuit 170 detect whether the output signal SQ is less than the predetermined level.

The low power consumption mode is a mode in which the power consumption of a circuit is lower than that in the normal operation mode. In the low power consumption mode of the amplifier circuit 141, for example, a bias current of an amplifier included in the amplifier circuit 141 is stopped or reduced to a low value. In the low power consumption mode of the A/D conversion circuit 142, for example, a bias current of an amplifier included in the A/D conversion circuit 142 is stopped or reduced to a low value. Alternatively, the clock signal input to the A/D conversion circuit 142 is stopped. In the low power consumption mode of the processing circuit 130, the input of the sensor detection information SSD to the processing circuit 130 is stopped. Alternatively, the clock signal input to the processing circuit 130 is stopped.

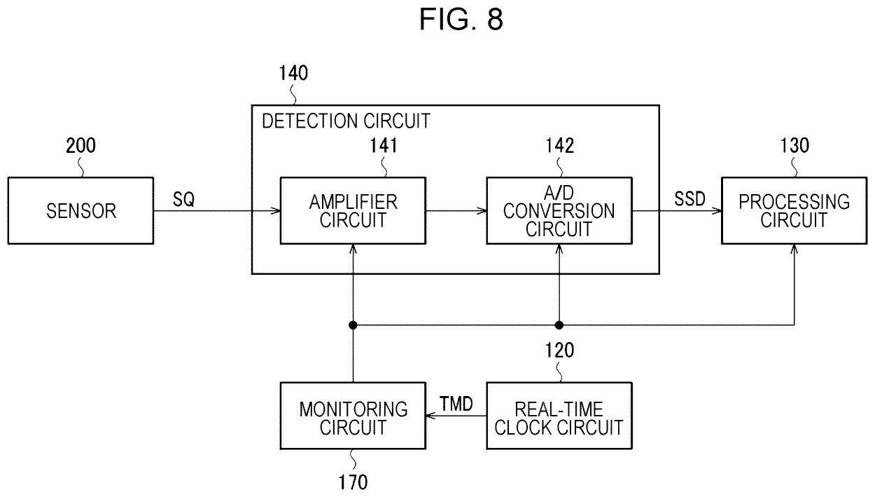

FIG. 8 is a block diagram illustrating a second configuration example in which the power consumption of the detection circuit 140 and the processing circuit 130 is reduced. The integrated circuit device 100 further includes the monitoring circuit 170. The monitoring circuit 170 mentioned here is a logic circuit and may be provided separately from the real-time clock circuit 120 and the processing circuit 130, may be included in the real-time clock circuit 120, or may be included in the processing circuit 130.

Based on the time information TMD generated by the real-time clock circuit 120, when a predetermined time is reached, the monitoring circuit 170 causes the detection circuit 140 and the processing circuit 130 to shift from the low power consumption mode to the normal operation mode or to shift from the normal operation mode to the low power consumption mode. Alternatively, based on the time information TMD, the monitoring circuit 170 may set the detection circuit 140 and the processing circuit 130 to the normal operation mode during a predetermined period and set the detection circuit 140 and the processing circuit 130 to the low power consumption mode outside the predetermined period.

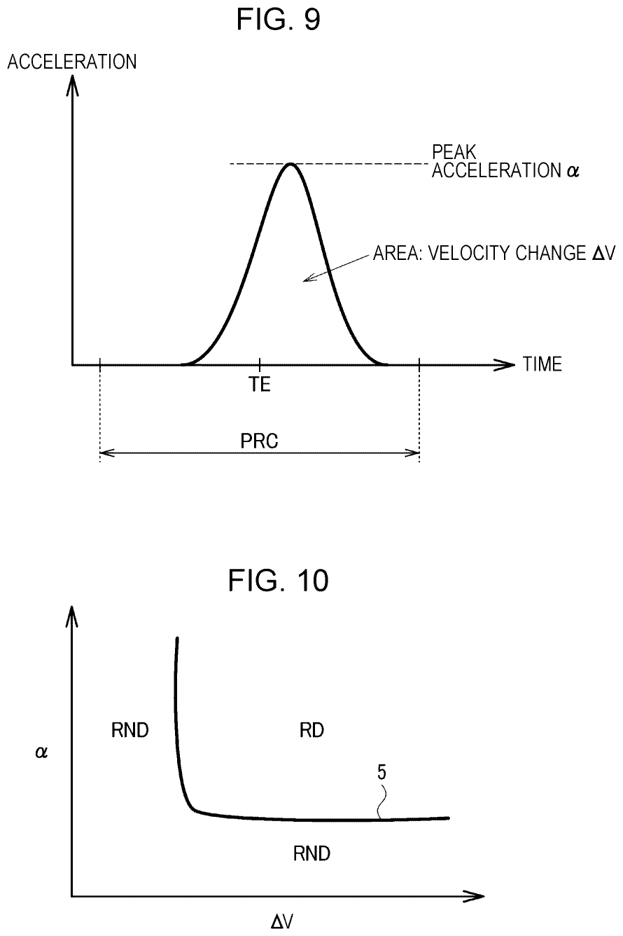

FIG. 9 shows a signal waveform example of acceleration generated when a single impact is applied to the sensor module 600. The signal waveform of the acceleration generated when an impact is applied is, for example, a waveform called a half-sine wave. It is assumed that the peak acceleration of the signal waveform is α and the velocity change is ΔV. The velocity change ΔV corresponds to an area obtained by integrating the signal waveform. An event occurrence time TE and a predetermined period PRC will be described later.

FIG. 10 is a graph illustrating a damage boundary curve. The damage boundary curve may be abbreviated as DBC. The damage boundary curve 5 illustrated in FIG. 10 is defined in a plane in which the horizontal axis represents the velocity change ΔV and the vertical axis represents the peak acceleration α. The damage boundary curve 5 is approximately L-shaped. Of the regions partitioned by the damage boundary curve 5, the region where the velocity change ΔV and the peak acceleration α are large is a damage region RD, and the region where the velocity change ΔV and the peak acceleration α are small is a non-damage region RND. When the velocity change ΔV and the peak acceleration α belonging to the damage region RD are applied to an object, the object is likely to be damaged. The damage boundary curve 5 is determined, for example, by evaluating whether the object is damaged by an impact.

The sensor module 600 detects impact information using an acceleration sensor and records the impact information and the time information TMD in association with each other as log information. Use of this log information enables verification of whether an impact exceeding the damage boundary curve 5 is applied to an object to be transported, that is, whether the velocity change ΔV and the peak acceleration α belonging to the damage region RD are applied to the object. If the impact exceeding the damage boundary curve 5 is applied to the object to be transported, it is also enabled to know the time of impact application and to estimate at which stage of the physical distribution the impact is applied.

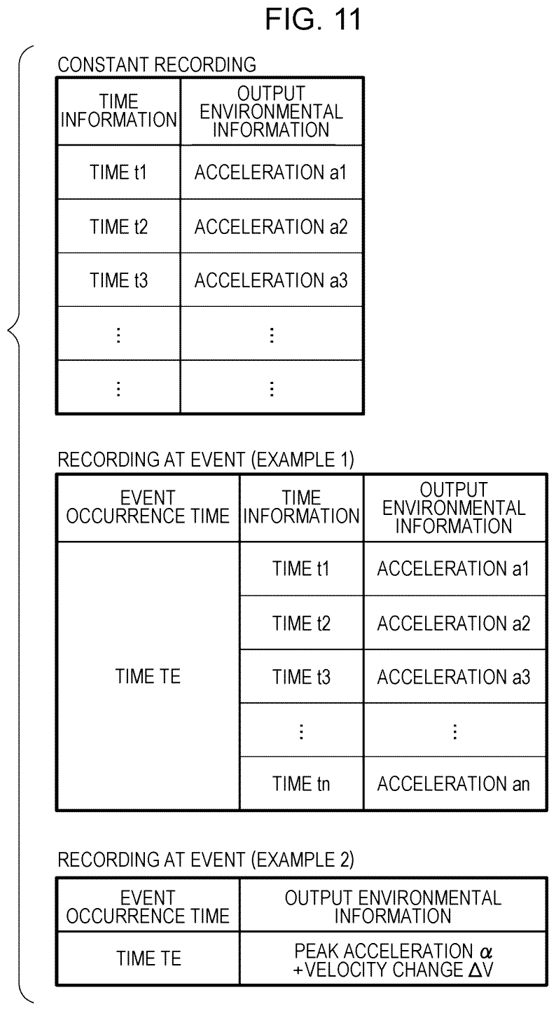

FIG. 11 illustrates examples of the log information LGD. As illustrated in the table of “constant recording”, the processing circuit 130 may constantly record the acceleration detected in time series, together with the time information, in the storage circuit 150. In this case, the processing circuit 130 records a time t1 and an acceleration a1 detected at the time t1 in association with each other, records a time t2 and an acceleration a2 detected at the time t2 in association with each other, records a time t3 and an acceleration a3 detected at the time t3 in association with each other, and so on. The times t1, t2, t3, etc., are time series in which accelerations are detected, and are, for example, time series at equal intervals.

As illustrated in the two tables of “recording at event”, the processing circuit 130 may record the log information LGD in association with the event occurrence time TE in the storage circuit 150. As illustrated in the table of (Example 1), the processing circuit 130 records the acceleration in the predetermined period PRC based on the event occurrence time TE. In FIG. 9, an example of the predetermined period PRC, which is a period of a predetermined length centered on the event occurrence time TE, is shown. A method for detecting the occurrence of an event will be described later. The predetermined period PRC is not limited to the example of FIG. 9, and, for example, the event occurrence time TE may be included at an arbitrary timing within the predetermined period PRC. Alternatively, the predetermined period PRC may be a period starting from the event occurrence time TE or a period ending at the event occurrence time TE. The predetermined period PRC includes times t1 to tn at which the accelerations a1 to an are detected, respectively. The processing circuit 130 records the times and the accelerations detected respectively at the times in association with each other. As the log information, the event occurrence time TE may be omitted, or the times t1 to tn may be omitted.

As illustrated in the table of (Example 2), the processing circuit 130 records the event occurrence time TE and the information used for impact determination using DBC in association with each other in the storage circuit 150. The processing circuit 130 uses the signal waveform of an acceleration near the event occurrence time TE to acquire information used for impact determination using DBC. Specifically, the processing circuit 130 acquires the peak acceleration α by performing peak detection on a signal waveform, acquires the velocity change ΔV by integrating the signal waveform, and records the peak acceleration α and the velocity change ΔV as information used for impact determination using DBC.

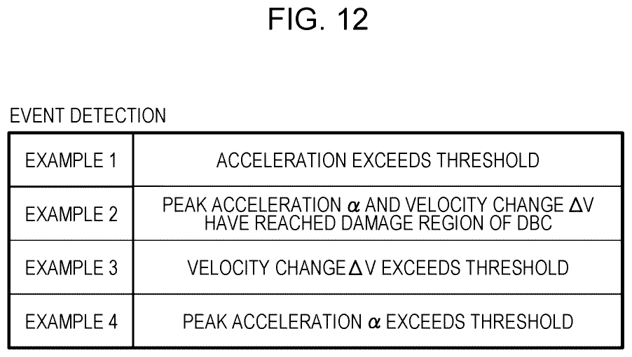

FIG. 12 illustrates an example of an event detection method. As illustrated in Example 1, the processing circuit 130 determines whether the acceleration exceeds a threshold, and sets, as the event occurrence time TE, the time at which it is determined that the acceleration exceeds the threshold level.

As illustrated in Example 2, the processing circuit 130 determines the peak acceleration α and the velocity change ΔV from the detected acceleration, and determines whether the peak acceleration α and the velocity change ΔV have reached the damage region RD of the DBC. The processing circuit 130 sets, as the event occurrence time TE, the time at which it is determined that the peak acceleration α and the velocity change ΔV have reached the damage region RD.

As illustrated in Example 3, the processing circuit 130 obtains the velocity change ΔV from the detected acceleration and determines whether the velocity change ΔV exceeds a threshold. The processing circuit 130 sets, as the event occurrence time TE, the time at which it is determined that the velocity change ΔV exceeds the threshold.

As illustrated in Example 4, the processing circuit 130 obtains the peak acceleration α from the detected acceleration and determines whether the peak acceleration α exceeds a threshold. The processing circuit 130 sets, as the event occurrence time TE, the time at which it is determined that the peak acceleration α exceeds the threshold.

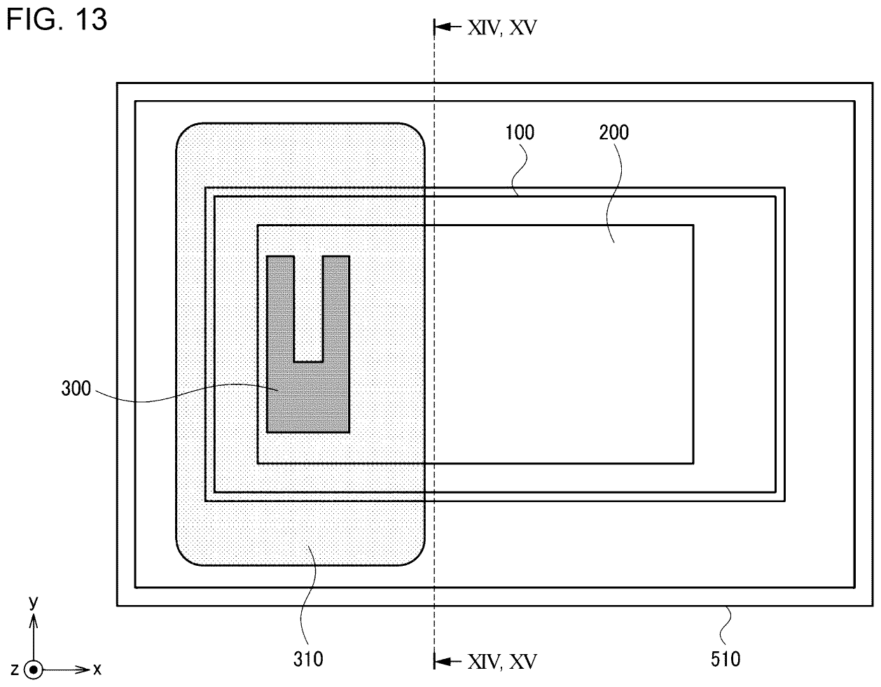

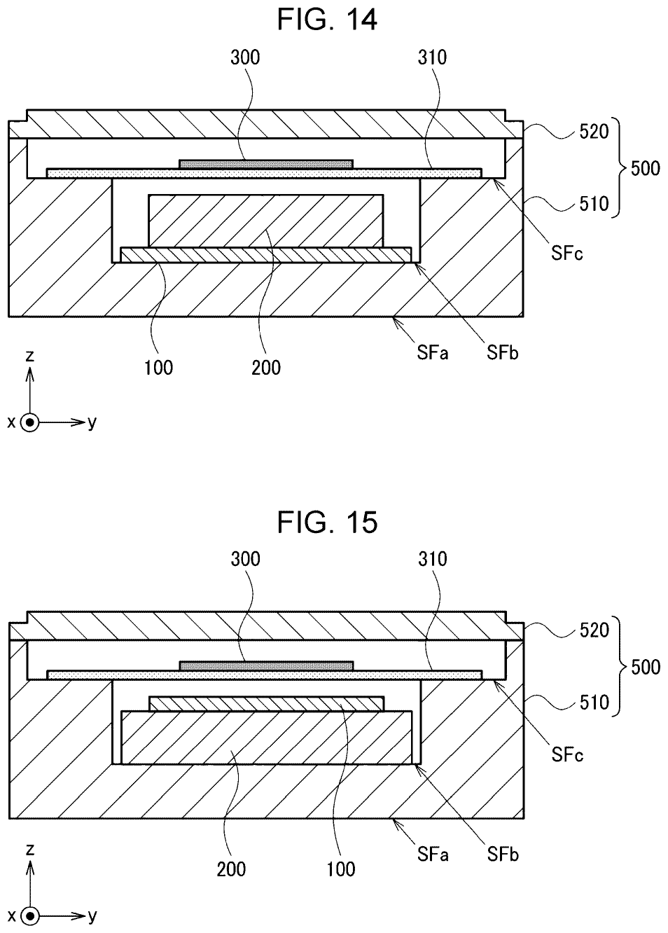

FIGS. 13 and 14 illustrate a first structural example of the sensor module 600. FIG. 13 is a plan view of the sensor module 600 when viewed along the −z direction, and FIG. 14 is a cross-sectional view when an XIV, XX-XIV, XX cross section in the plan view is viewed in the −x direction. In the drawings related to hereafter, the external connection terminal TM and in-package wiring are not illustrated. Additionally, in the plan view, a lid 520 of the package 500 is not illustrated. Additionally, the +z direction may be referred to as up, and the −z direction may be referred to as down.

The package 500 includes a base 510 having a recess, and a lid 520, which is a lid of the base 510. The bottom surface SFa of the base 510 is parallel to the xy-plane, and the recess of the base 510 opens upward. The lid 520 covers the recess such that the edge of the lid 520 is bonded to the edge of the recess of the base 510, thus sealing the integrated circuit device 100, the sensor 200, and the resonator 300 in the package 500.

The recess of the base 510 has a bottom surface SFb and a step surface SFc provided above the bottom surface SFb. The integrated circuit device 100 is disposed on the bottom surface SFb, and the sensor 200 is disposed on top of the integrated circuit device 100. The integrated circuit device 100 is, for example, a bare chip. The sensor 200 is, for example, a substantially rectangular parallelepiped. The integrated circuit device 100 and the sensor 200 are arranged such that the thickness direction thereof is the z direction. The resonator 300 is, for example, a quartz crystal resonator and is formed on a quartz crystal relay substrate 310. With an end portion of the relay substrate 310 bonded to the stepped surface SFc, the resonator 300 is housed in the base 510. FIGS. 13 and 14 illustrate an example in which the relay substrate 310 is disposed in the −x direction with respect to the center of the base 510 and three sides of the relay substrate 310 are bonded to the stepped surface SFc. In plan view, the resonator 300 may overlap the integrated circuit device 100 and the sensor 200 or may overlap only the integrated circuit device 100.

The integrated circuit device 100 and the sensor 200 are connected to each other by in-package wiring. The in-package wiring includes a bonding wire or wiring provided inside or on the inner surface of the structure of the base 510. For example, the integrated circuit device 100 includes a pad formed of the uppermost layer metal, and the sensor 200 includes a wiring connection terminal. The pad of the integrated circuit device 100 and the terminal of the sensor 200 may be connected to each other by a bonding wire or may be temporarily connected to each other via the wiring of the base 510. In the latter case, the pad of the integrated circuit device 100 and the terminal of the sensor 200 may be connected to the wiring of the base 510 using a bonding wire or a bump. Similarly, the integrated circuit device 100 and the resonator 300 are connected to each other by in-package wiring.

FIG. 15 illustrates a second structural example of the sensor module 600. The plan view is the same as FIG. 13, and FIG. 15 is a cross-sectional view when the XIV, XV-XIV, XV cross section in the plan view is viewed in the −x direction. In this example, the sensor 200 is disposed on the bottom surface SFb, and the integrated circuit device 100 is disposed on top of the sensor 200.

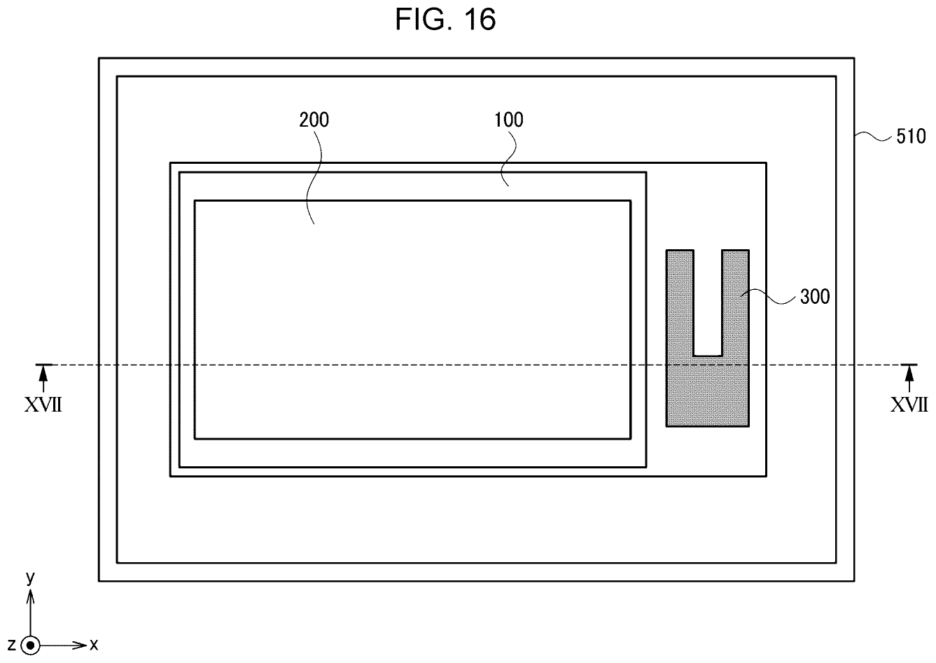

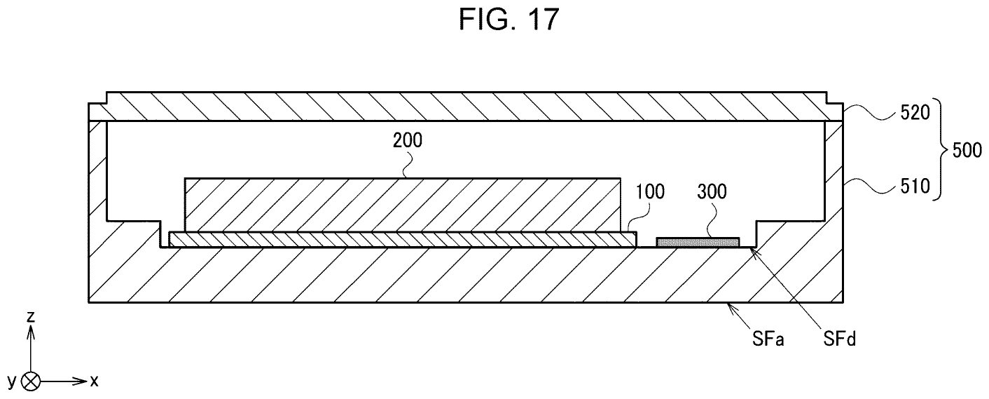

FIGS. 16 and 17 illustrate a third structural example of the sensor module 600. FIG. 16 is a plan view of the sensor module 600 when viewed in the −z direction, and FIG. 17 is a cross-sectional view when the XVII-XVII cross section in the plan view is viewed in the +y direction. Portions different from those in the first structural example will be described.

The recess of the base 510 has a bottom surface SFd. The integrated circuit device 100 is disposed on the bottom surface SFd, and the sensor 200 is disposed on top of the integrated circuit device 100. The resonator 300 is disposed on the bottom surface SFd of the recess at a position at which the resonator 300 does not overlap the integrated circuit device 100 in plan view. FIGS. 16 and 17 illustrate an example in which the resonator 300 is disposed on the +x direction side of the integrated circuit device 100. The sensor 200 may be disposed on the bottom surface SFd of the recess, and the integrated circuit device 100 may be disposed on top of the sensor 200.

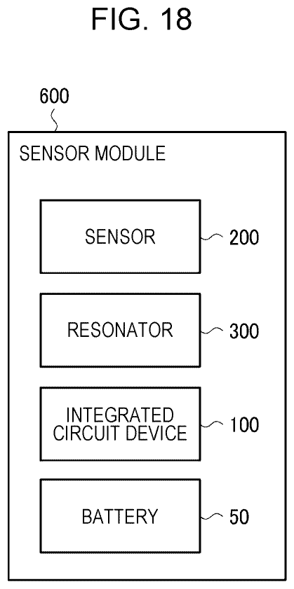

FIG. 18 illustrates a first example of a battery arrangement. The sensor module 600 includes a sensor 200, a resonator 300, an integrated circuit device 100, and a battery 50.

The battery 50, together with the sensor 200, the resonator 300, and the integrated circuit device 100, is housed in the package 500. A terminal of the battery 50 is connected to a power supply terminal of the integrated circuit device 100 by in-package wiring. The battery 50 chemically or electrically stores electric energy and is, for example, a primary battery, secondary battery, or capacitor. As the primary battery, for example, a small button battery is assumed. The secondary battery is, for example, a lithium ion battery. The capacitor may be an electrolytic capacitor or other component, or may be a so-called supercapacitor.

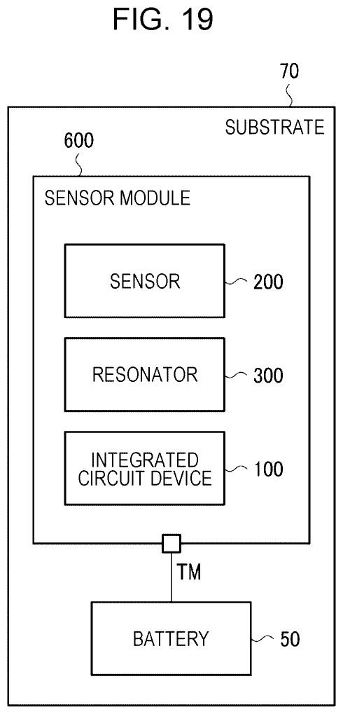

FIG. 19 illustrates a second example of the battery arrangement. The sensor module 600 and the battery 50 are mounted on the substrate 70. The substrate 70 is a substrate incorporated in an object equipped with the sensor module 600. The object equipped with the sensor module 600 is the electronic device 10 in FIG. 2, the environmental data logger 30 in FIG. 3, or other device. A terminal of the battery 50 is connected to the external connection terminal TM provided in the package 500 of the sensor module 600. The external connection terminal TM is connected to a power supply terminal of the integrated circuit device 100 by in-package wiring.

In the present embodiment, the sensor module 600 includes the sensor 200, the resonator 300, the integrated circuit device 100, and the package 500. The sensor 200 detects environmental information of an object equipped with the sensor module 600. The package 500 houses the sensor 200, the resonator 300, and the integrated circuit device 100. The integrated circuit device 100 includes an oscillation circuit 110, a real-time clock circuit 120, and a processing circuit 130. The oscillation circuit 110 generates a clock signal CK using the resonator 300. The real-time clock circuit 120 generates time information TMD based on the clock signal CK. The processing circuit 130 outputs the output environmental information based on the output signal SQ of the sensor 200 and the time information TMD from the real-time clock circuit 120 in association with each other as the log information LGD.

According to the present embodiment, the environmental information is detected using the sensor 200 and is recorded together with the time information by the real-time clock circuit 120, enabling the environmental data logger in the physical distribution process to be configured. By collating such log information with information indicating the time at which each stage of the physical distribution is performed, it is possible to estimate environmental information at each stage of the physical distribution. In addition, the sensor 200, the integrated circuit device 100, and the resonator 300 are housed in the package 500 to configure the sensor module 600, and thus it is possible to solve various disadvantages of the environmental data logger. For example, a compact, low-power-consumption, and inexpensive environmental data logger may be configured. That is, since it is possible to configure the compact and inexpensive sensor module 600 in the present embodiment, the sensor module 600 is easily used for a transportation target of any size or price. In addition, since the sensor module 600 in the present embodiment allows reduction in power consumption, it is possible to continuously operate the sensor module 600 during the transportation time even when the battery has a small capacity and is light.

In addition, in the present embodiment, the package 500 includes external connection terminals TM for mounting the package 500 on a substrate of an object equipped with the sensor module 600.

According to the present embodiment, the sensor 200, the integrated circuit device 100, and the resonator 300 are housed in the package 500 that is small enough to be mounted on the substrate. The package 500 in such a manner may be considered to be a single component mounted on a printed circuit board or other substrate and is much smaller than a general electronic device in which multiple components are combined and housed together in a casing.

In addition, in the present embodiment, the package 500 may include the base 510 and the lid 520. The base 510 holds the sensor 200, the resonator 300, and the integrated circuit device 100, and may be provided with an external connection terminal TM. The lid 520 may be bonded to the base 510.

According to the present embodiment, for example, the sensor module 600 may be configured using the small package 500 such as a ceramic package of the type used in oscillators with crystal resonators, sensors, or similar devices.

In addition, in the present embodiment, the external connection terminal TM may be a terminal that outputs the log information LGD to the outside of the sensor module 600.

In addition, in the present embodiment, the integrated circuit device 100 may include the interface circuit 160 for outputting the log information LGD to the outside of the sensor module 600 through the external connection terminal TM.

According to the present embodiment, the sensor module 600 may output the log information LGD to the outside via the external connection terminal TM. For example, the processor of an electronic device or an environmental data logger equipped with the sensor module 600 may read the log information LGD from the sensor module 600 via the external connection terminal TM.

In addition, in the present embodiment, the sensor 200, the resonator 300, and the integrated circuit device 100 may be connected to each other by in-package wiring of the package 500.

In addition, in the present embodiment, the in-package wiring may include a bonding wire.

According to the present embodiment, the sensor 200, the resonator 300, and the integrated circuit device 100 are housed in the package 500 and are connected to each other by the in-package wiring, enabling implementation of the small sensor module 600.

In addition, in the present embodiment, the longest side of the package 500 may have the length WD less than or equal to 20 mm.

Such a size of the package 500 allows the sensor module 600 to be easily mounted on a substrate or allows the sensor module 600 to be easily used for transportation targets having various sizes.

In addition, in the present embodiment, the sensor 200 may be a sensor that detects, as the environmental information, impact information on an object equipped with the sensor module 600.

According to the present embodiment, the sensor module 600 is a shock data logger and can record the log information LGD in which the output environmental information based on the impact information is associated with the time information TMD. By referring to the log information LGD, it is possible to know when the impact is applied to an object equipped with a sensor module or when and what kind of impact is applied to the object equipped with the sensor module.

In addition, in the present embodiment, the output environmental information may be information used for impact determination using a damage boundary curve.

According to the present embodiment, by referring to the log information LGD in which the output environmental information and the time information TMD are associated with each other, it is possible to know that an impact exceeding the damage boundary curve is applied and the time thereof.

In addition, in the present embodiment, the environmental information may be environmental information in at least one of packing, transportation, unpacking, and installation of an object equipped with a sensor module.

According to the present embodiment, by referring to the time information TMD recorded in the log information LGD and the record of the time at which at least one of the packing, transportation, unpacking, and installation is performed, it is possible to grasp the environmental information in each stage of at least one of the packing, transportation, unpacking, and installation.

In addition, in the present embodiment, the sensor 200 may be a temperature sensor that detects temperature information as the environmental information.

In addition, in the present embodiment, the temperature sensor may be included in the integrated circuit device 100.

According to the present embodiment, the sensor module 600 is a temperature logger and can record the log information LGD in which the output environmental information based on the temperature information is associated with the time information TMD. By referring to the log information LGD, it is possible to know the environmental temperature at each time, when the environmental temperature changes, or the like.

In addition, in the present embodiment, when a detection event of the environmental information occurs, the processing circuit 130 may output, as the log information LGD, the output environmental information and the time information TMD in association with each other.

According to the present embodiment, the log information LGD is output upon occurrence of a detection event of environmental information. Therefore, by referring to the log information LGD, it is possible to know a time at which a specific detection event occurred. By referring to the time at which the detection event occurred and the time at which packing, transportation, unpacking, installation, or the like was performed, it is possible to grasp which of packing, transportation, unpacking, and installation is the stage in which the detection event occurred.

In addition, in the present embodiment, the processing circuit 130 may output the log information LGD including the output environmental information within the predetermined period PRC based on the time TE of occurrence of a detection event.

According to the present embodiment, only the log information LGD near the time TE at which the detection event occurred is recorded, enabling the storage capacity of the storage circuit 150 to be largely saved as compared with the constant recording. Saving the storage capacity enables the integrated circuit device 100 to be made smaller and enables the sensor module 600 to be reduced in size.

In addition, in the present embodiment, the integrated circuit device 100 may include a detection circuit 140 that performs detection processing on the output signal SQ from the sensor 200 and outputs the resulting sensor detection information SSD. The processing circuit 130 may acquire the sensor detection information SSD as the output environmental information, or may calculate the sensor detection information SSD to acquire the output environmental information.

According to the present embodiment, as the log information LGD, the sensor detection information SSD itself may be recorded in association with the time information TMD, or information obtained by processing the sensor detection information SSD may be recorded in association with the time information TMD. The log information LGD may be recorded in a form corresponding to the use form of data.

In addition, in the present embodiment, the integrated circuit device 100 may include the detection circuit 140 and the storage circuit 150. The detection circuit 140 may perform detection processing on the output signal SQ from the sensor 200 and output the resulting sensor detection information SSD. The processing circuit 130 may cause the storage circuit 150 to store the output environmental information based on the sensor detection information SSD, and the time information TMD in association with each other as the log information LGD.

According to the present embodiment, it is possible to store the log information LGD in the storage circuit 150 and to read the log information LGD later by accessing the storage circuit 150 from the outside of the sensor module 600.

In addition, in the present embodiment, at least a portion among the detection circuit 140 and the processing circuit 130 may shift from the low power consumption mode to the normal operation mode when the output signal SQ of the sensor 200 reaches a predetermined value.

According to the present embodiment, only when the environmental information reaches a value to be detected, at least a portion among the detection circuit 140 and the processing circuit 130 can be set to the normal operation mode during a predetermined period. This way enables the low power consumption mode to be set when it is not necessary to detect the environmental information, thus enabling the power consumption of the sensor module 600 to be reduced compared to the case where the sensor module 600 is continuously in the normal operation mode.

In addition, in the present embodiment, at least a portion among the detection circuit 140 and the processing circuit 130 may shift from the low power consumption mode to the normal operation mode based on the time information TMD from the real-time clock circuit 120.

According to the present embodiment, when a predetermined time is reached, at least a portion among the detection circuit 140 and the processing circuit 130 may be shifted from the low power consumption mode to the normal operation mode. Alternatively, at least a portion among the detection circuit 140 and the processing circuit 130 is set to the normal operation mode or the low power consumption mode during a predetermined period. This way enables the low power consumption mode to be set when it is not necessary to detect the environmental information, thus enabling the power consumption of the sensor module 600 to be reduced compared to the case where the sensor module 600 is continuously in the normal operation mode.

In addition, in the present embodiment, the integrated circuit device 100 may operate based on power from the battery 50 housed in the package 500 or power from the battery 50 disposed in the object equipped with the sensor module 600.

According to the present embodiment, supply of power from the battery 50 to the sensor module 600 allows the sensor module 600 to continue to record the log information LGD in the physical distribution process.

Although the present embodiment is described in detail as described above, those skilled in the art could easily understand that many modifications may be made without substantially departing from new matters and effects of the present disclosure. Therefore, all such modifications are included in the scope of the present disclosure. For example, the terms described together with different terms having a broader meaning or the same meaning at least once in the specification or the drawings may be replaced with the different terms in any portion in the specification or the drawings. In addition, all combinations of the present embodiment and modifications are also included in the scope of the present disclosure. In addition, the configurations, operations, and the like of the detection circuit, real-time clock circuit, oscillation circuit, processing circuit, storage circuit, interface circuit, integrated circuit device, sensor, resonator, package, external connection terminal, electronic device, environmental data logger, sensor module, and the like are not limited to those described in the present embodiment, and various modifications may be made.

What is claimed is:

1. A sensor module comprising:
a sensor configured to detect environmental information of an object equipped with the sensor module;
a resonator;
an integrated circuit device; and
a package configured to house the sensor, the resonator, and the integrated circuit device, wherein
the integrated circuit device includes
an oscillation circuit configured to generate a clock signal using the resonator,
a real-time clock circuit configured to generate time information based on the clock signal, and
a processing circuit configured to output, as log information, output environmental information based on an output signal of the sensor and the time information from the real-time clock circuit in association with each other.

2. The sensor module according to claim 1, wherein
the package includes an external connection terminal for mounting on a substrate of the object equipped with the sensor module.

3. The sensor module according to claim 2, wherein
the package includes
a base configured to house the sensor, the resonator, and the integrated circuit device and provided with the external connection terminal, and
a lid bonded to the base.

4. The sensor module according to claim 2, wherein
the external connection terminal is a terminal configured to output the log information to an outside of the sensor module.

5. The sensor module according to claim 4, wherein
the integrated circuit device includes an interface circuit for outputting the log information to the outside of the sensor module via the external connection terminal.

6. The sensor module according to claim 1, wherein
the sensor, the resonator, and the integrated circuit device are connected to each other by in-package wiring of the package.

7. The sensor module according to claim 6, wherein
the in-package wiring includes a bonding wire.

8. The sensor module according to claim 1, wherein
a longest side of the package has a length less than or equal to 20 mm.

9. The sensor module according to claim 1, wherein
the sensor is a sensor configured to detect, as the environmental information, impact information on the object equipped with the sensor module.

10. The sensor module according to claim 9, wherein
the output environmental information is information used for impact determination using a damage boundary curve.

11. The sensor module according to claim 1, wherein
the environmental information is environmental information in at least one of packing, transportation, unpacking, and installation of the object equipped with the sensor module.

12. The sensor module according to claim 1, wherein
the sensor is a temperature sensor configured to detect temperature information as the environmental information.

13. The sensor module according to claim 12, wherein
the temperature sensor is included in the integrated circuit device.

14. The sensor module according to claim 1, wherein
the sensor is a condensation sensor configured to detect a condensation state as the environmental information.

15. The sensor module according to claim 1, wherein
the processing circuit is configured to, upon an occurrence of a detection event of the environmental information, output, as the log information, the output environmental information and the time information in association with each other.

16. The sensor module according to claim 15, wherein
the processing circuit is configured to output the log information including the output environmental information within a predetermined period based on a time of the occurrence of the detection event.

17. The sensor module according to claim 1, wherein
the integrated circuit device includes a detection circuit configured to perform detection processing on an output signal from the sensor and to output sensor detection information, and
the processing circuit configured to acquire the sensor detection information as the output environmental information, or to calculate the sensor detection information to acquire the output environmental information.

18. The sensor module according to claim 1, wherein
the integrated circuit device includes
a detection circuit configured to perform detection processing on an output signal of the sensor and to output sensor detection information, and
a storage circuit, and
the processing circuit is configured to cause the storage circuit to store the output environmental information based on the sensor detection information, and the time information in association with each other as the log information.

19. The sensor module according to claim 18, wherein
at least a portion among the detection circuit and the processing circuit is configured to shift from a low power consumption mode to a normal operation mode when the output signal of the sensor reaches a predetermined value.

20. The sensor module according to claim 18, wherein
at least a portion among the detection circuit and the processing circuit is configured to shift from a low power consumption mode to a normal operation mode based on the time information from the real-time clock circuit.

21. The sensor module according to claim 1, wherein
the integrated circuit device is configured to operate based on power from a battery housed in the package or power from a battery disposed in the object equipped with the sensor module.
